(19) United States
(12) Patent Application Publication
(10) Pub. No.: US 2024/0302247 A1
(43) Pub. Date: Sep. 12, 2024

(54) TIRE CORNERING STIFFNESS ESTIMATION METHOD, ROAD SURFACE CONDITION DETECTION METHOD USING TIRE CORNERING STIFFNESS ESTIMATION VALUE, AND APPARATUS FOR PERFORMING THE SAME

(71) Applicant: HL Mando Corporation, Pyeongtaek-si (KR)

(72) Inventor: Sangjin KO, Daejeon (KR)

(73) Assignee: HL Mando Corporation, Pyeongtaek-si (KR)

(21) Appl. No.: 18/385,077

(22) Filed: Oct. 30, 2023

(30) Foreign Application Priority Data
Mar. 7, 2023 (KR) 10-2023-0029697

(51) Int. Cl. G01M 17/02; B60C 19/00

(52) U.S. Cl. CPC G01M 17/02; B60C 19/00; B60C 2019/004

(57) ABSTRACT

In a method and apparatus for estimating a cornering stiffness of a tire and detecting a road surface condition according to the present disclosure, the tire cornering stiffness can be estimated based on information obtainable from a vehicle and a simple model without using a separate sensor or a complex vehicle dynamics model for estimating cornering stiffness, and the road surface condition can be detected using a tire cornering stiffness estimation value based on information obtainable from the vehicle without using a separate sensor for estimating the road surface condition.

### CROSS-REFERENCE TO RELATED APPLICATION

This application claims the benefit of priority to Korean Patent Application No. 10-2023-0029697, filed on Mar. 7, 2023 in the Korean Intellectual Property Office, the entire content of which is incorporated herein by reference.

### TECHNICAL FIELD

The present disclosure relates to a tire cornering stiffness estimation method, a road surface condition detection method using a tire cornering stiffness estimation value, and an apparatus for performing the same, and more specifically, to a method and apparatus for estimating a cornering stiffness of a tire and detecting a road surface condition.

### BACKGROUND

Cornering stiffness of a tire represents tire-road characteristics and determines tire lateral force. The tire lateral force is a source of generating the lateral motion of a vehicle. Accordingly, the cornering stiffness, which determines the tire lateral force, is important information. There are several methods for estimating the cornering stiffness, but the conventional methods involve the design of vehicle state estimators based on expensive sensors (IMU, GPS, etc.) or complex vehicle dynamics model, so there are limitations in applying the conventional methods to actual mass-produced vehicles due to cost/accuracy/implementation problems.

In addition, road surface condition estimation is very important information for vehicle control, and is important information necessary for autonomous driving technology as well as control systems for chassis such as steering/braking/suspension. There are several methods for estimating the road surface condition, but most of the conventional methods estimate the road surface condition using an additional sensor. For example, a separate sensor such as a vibration sensor or an acoustic sensor is attached to a bottom portion of the vehicle to estimate the road surface condition based on the sensor value, but there is a problem in that the separate sensor is required and the accuracy thereof is low. Recently, a number of road surface estimation methods based on camera image data have been proposed using deep learning technology. However, the conventional road surface estimation methods require a separate sensor and a high-performance computing device to apply deep learning, and have a great limitation on the environment such as at night, which decreases the accuracy.

### SUMMARY

In view of the above, the present disclosure provides a tire cornering stiffness estimation method for estimating cornering stiffness of a tire based on information obtainable from a vehicle and a simple model, and an apparatus for performing the same.

In addition, the present disclosure provides a road surface condition detection method using a tire cornering stiffness estimation value, which detects a road surface condition using a cornering stiffness estimation value of a tire based on information that can be obtained from a vehicle, and an apparatus for performing the same.

Other objects of the present disclosure not specified may be additionally considered within the scope that can be easily inferred from the following detailed description and effects thereof.

A tire cornering stiffness estimation method, according to an exemplary embodiment of the present disclosure, includes: obtaining vehicle driving information; and estimating cornering stiffness of a tire based on the vehicle driving information using a bicycle model and a linear tire model, which are vehicle lateral dynamics models.

The vehicle driving information may include a lateral acceleration of a vehicle, a yaw rate of the vehicle, and a longitudinal speed of the vehicle.

The estimating of the cornering stiffness may include: obtaining a lateral speed based on the vehicle driving information; obtaining a first tire lateral force based on the vehicle driving information; obtaining a scaling factor for reflecting influence of tire vertical force based on the vehicle driving information; obtaining a slip angle based on the vehicle driving information and the lateral speed; obtaining a second tire lateral force based on the first tire lateral force and the scaling factor; and obtaining a cornering stiffness estimation value based on the second tire lateral force and the slip angle.

The obtaining of the lateral speed may include calculating the lateral speed v_{y} based on the lateral acceleration a_{y}, the yaw rate r, and the longitudinal speed vₓ.

The obtaining of the first tire lateral force may include: calculating a first front wheel tire lateral force F_{yf} based on the lateral acceleration a_{y}, the yaw rate r, a total length L between front and rear wheels, a z-axis moment of inertia I_{z}, a mass m of the vehicle, and a rear wheel length lᵣ between a center of the front and rear wheels and the rear wheel; calculating a first rear tire lateral force F_{yr} based on the lateral acceleration a_{y}, the yaw rate r, the total length L, the z-axis moment of inertia I_{z}, the mass m, and a front wheel length l_{f} between the center of the front and rear wheels and the front wheel; and obtaining the first tire lateral force including the first front tire lateral force F_{yf} and the first rear wheel tire lateral force F_{yr}.

The obtaining of the scaling factor may include obtaining the scaling factor k_{scale} corresponding to the lateral acceleration a_{y} using scaling factor information in which scaling factors are mapped for respective lateral accelerations.

The obtaining of the slip angle may include: calculating a front wheel slip angle α_{f} based on the yaw rate r, the longitudinal speed vₓ, the lateral speed v_{y}, and the front wheel length l_{f}; calculating a rear wheel slip angle αᵣ based on the yaw rate r, the longitudinal speed vₓ, the lateral speed v_{y}, and the rear wheel length lᵣ; and obtaining the slip angle including the front wheel slip angle α_{f} and the rear wheel slip angle αᵣ.

The obtaining of the second tire lateral force may include: calculating a second front tire lateral force F_{yfs} based on the first front tire lateral force F_{yf} and the scaling factor k_{scale}; calculating a second rear tire lateral force F_{yrs} based on the first rear tire lateral force F_{yr} and the scaling factor k_{scale}; and obtaining the second tire lateral force including the second front tire lateral force F_{yfs} and the second rear tire lateral force F_{yrs}.

The obtaining of the cornering stiffness estimation value may include: calculating a front wheel cornering stiffness estimation value C_{f,est} based on the second front tire lateral force F_{yfs} and the front wheel slip angle α_{f}; calculating a rear wheel cornering stiffness estimation value C_{f,est} based on the second rear tire lateral force F_{yrs} and the rear wheel slip angle αᵣ; and obtaining the cornering stiffness estimation value including the front wheel cornering stiffness estimation value C_{f,est} and the rear wheel cornering stiffness estimation value C_{f,est}.

The estimating of the cornering stiffness may include: estimating the cornering stiffness when a preset driving condition is satisfied; and maintaining a previously estimated cornering stiffness when the driving condition is not satisfied.

The driving condition may include a case where an absolute value of variation of the longitudinal speed vₓ is less than a preset first reference value and an absolute value of the lateral acceleration a_{y} is less than a preset second reference value.

A tire cornering stiffness estimation apparatus, according to an exemplary embodiment of the present disclosure, includes: a memory storing one or more programs for estimating tire cornering stiffness; and one or more processors that perform an operation for estimating tire cornering stiffness according to the one or more programs stored in the memory, wherein the processors perform: obtaining vehicle driving information; and estimating cornering stiffness of a tire based on the vehicle driving information using a bicycle model and a linear tire model, which are vehicle lateral dynamics models.

The processor may perform controlling at least one of a steering system, a braking system, or a suspension system of the vehicle by using the estimated cornering stiffness of the tire.

The vehicle driving information may include a lateral acceleration of a vehicle, a yaw rate of the vehicle, and a longitudinal speed of the vehicle.

The processors may perform: obtaining a lateral speed based on the vehicle driving information; obtaining a first tire lateral force based on the vehicle driving information; obtaining a scaling factor for reflecting influence of tire vertical force based on the vehicle driving information; obtaining a slip angle based on the vehicle driving information and the lateral speed; obtaining a second tire lateral force based on the first tire lateral force and the scaling factor; and obtaining a cornering stiffness estimation value based on the second tire lateral force and the slip angle.

A road surface condition detection method using a tire cornering stiffness estimation value, according to an exemplary embodiment of the present disclosure, includes: obtaining vehicle driving information; and detecting a road surface condition based on cornering stiffness of a tire estimated based on the vehicle driving information.

The detecting of the road surface condition may include: obtaining a cornering stiffness estimation value based on the vehicle driving information using a bicycle model and a linear tire model, which are vehicle lateral dynamics models; and obtaining the road surface condition corresponding to the cornering stiffness estimation value by using cornering stiffness information in which road surface conditions are mapped for respective cornering stiffness ranges.

The obtaining of the road surface condition may include: obtaining a cornering stiffness range corresponding to the cornering stiffness estimation value from the cornering stiffness information; and obtaining a road surface condition corresponding to the obtained cornering stiffness range as the road surface condition corresponding to the cornering stiffness estimation value.

In the cornering stiffness information, the road surface conditions may be mapped for the respective cornering stiffness ranges using a boundary reference value set based on a physical phenomenon of a road surface and a boundary adjustment value changeable based on vehicle characteristics.

The detecting of the road surface condition may include: detecting the road surface condition when a preset driving condition is satisfied; and maintaining a previously detected road surface condition when the driving condition is not satisfied.

The road surface condition may include a dry state, a wet state, a snow state, and an ice state.

In the tire cornering stiffness estimation method according to the exemplary embodiment of the present disclosure, and the apparatus for performing the same, by estimating the cornering stiffness of a tire based on information obtainable from the vehicle and the simple model, it is possible to estimate the cornering stiffness without using a separate sensor or complex vehicle dynamics model for estimating cornering stiffness.

In addition, in the road surface condition detection method using the tire cornering stiffness estimation value according to the exemplary embodiment of the present disclosure, and the apparatus for performing the same, by detecting the road surface condition using the cornering stiffness estimation value of the tire based on information obtainable from the vehicle, it is possible to detect the road surface condition without using a separate sensor for estimating the road surface condition.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is a block diagram for explaining an apparatus according to an exemplary embodiment of the present disclosure.

FIG. 2 is a flowchart illustrating a tire cornering stiffness estimation method according to an exemplary embodiment of the present disclosure.

FIG. 3 is a flowchart for explaining a step of estimating cornering stiffness shown in FIG. 2.

FIG. 4 is a diagram for explaining a bicycle model, which is a vehicle lateral dynamics model according to an exemplary embodiment of the present disclosure.

FIG. 5 is a diagram for explaining influence of tire vertical force on tire lateral force according to an exemplary embodiment of the present disclosure.

FIG. 6 is a diagram for explaining scaling factor information according to an exemplary embodiment of the present disclosure.

FIG. 7 is a diagram for explaining the relationship between a side slip angle and a tire lateral force according to an exemplary embodiment of the present disclosure.

FIG. 8 is a flowchart illustrating a road surface condition detection method using a tire cornering stiffness estimation value according to an exemplary embodiment of the present disclosure.

FIG. 9 is a flowchart for explaining a step of detecting a road surface condition shown in FIG. 8.

FIG. 10 is a diagram for explaining cornering stiffness information according to an exemplary embodiment of the present disclosure.

### DETAILED DESCRIPTION

Hereinafter, embodiments of the present disclosure will be described in detail with reference to the accompanying drawings. Advantages and features of the present disclosure, and methods of achieving them, will become clear with reference to the embodiments described below in detail in conjunction with the accompanying drawings. However, the present disclosure is not limited to the embodiments described below and may be implemented in a variety of different forms. These embodiments are merely provided to complete the disclosure of the present disclosure and to completely inform those skilled in the art to which the present disclosure pertains of the scope of the present disclosure, and the present disclosure is defined only by the scope of the claims. Like reference numbers designate like components throughout the present specification.

Unless otherwise defined, all terms (including technical and scientific terms) used in the present specification may be used in a meaning commonly understood by those skilled in the art to which the present disclosure pertains. In addition, terms defined in commonly used dictionaries are not interpreted ideally or excessively unless explicitly specifically defined.

In the present specification, terms such as “first”, “second”, and the like are used to distinguish one component from another, and the scope of the present disclosure should not be limited by these terms. For example, a first component may be referred to as a second component, and similarly, the second component may also be referred to as the first component.

In the present specification, identification codes (e.g., a, b, c, etc.) for each step are used for convenience of description, and the identification codes do not describe the order of each step. Each step may occur in a different order from the specified order unless the specific order is clearly stated in context. That is, the steps may be performed in the order as specified, may be performed substantially simultaneously, or may be performed in the reverse order to the order as specified.

In the present specification, expressions such as “have”, “may have”, “include” or “may include” indicate the existence of a corresponding feature (e.g., a component such as numerical value, function, operation, or part), and does not preclude the presence of additional features.

Hereinafter, a method for estimating tire cornering stiffness, a method for detecting road surface conditions using a tire cornering stiffness estimation value, and an apparatus for performing the methods, according to the present disclosure, will be described in detail with reference to the accompanying drawings.

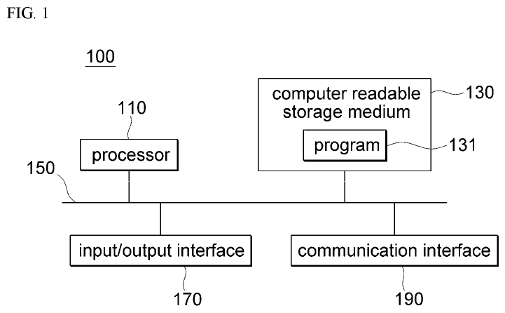

First, an apparatus according to an exemplary embodiment of the present disclosure will be described with reference to FIG. 1.

FIG. 1 is a block diagram for explaining the apparatus according to an exemplary embodiment of the present disclosure.

Referring to FIG. 1, an apparatus 100 according to the exemplary embodiment of the present disclosure can estimate cornering stiffness of a tire based on information obtainable from a vehicle and a simple model. Accordingly, according to the present disclosure, it is possible to estimate cornering stiffness without using a separate sensor or a complex vehicle dynamics model for estimating cornering stiffness.

In other words, based on a simple model such as a bicycle model, which is a vehicle lateral dynamics model that has no longitudinal acceleration and has the same characteristics of left and right tires, and a linear tire model that considers only linear sections, the present disclosure proposes a cornering stiffness estimation method, which is easy to apply to mass-produced vehicles, using lateral acceleration, yaw rate, and longitudinal speed, which are signals available in current mass-produced vehicles without using separate sensors or complex vehicle dynamics models. The estimated cornering stiffness can be used as important information for road surface determination or steering/braking/suspension control algorithms. Since a braking control device is installed in the vehicle, it is possible to basically use a lateral acceleration signal, a yaw rate signal, and a longitudinal speed signal. Using a relationship of “tire cornering stiffness→tire lateral force→vehicle lateral motion→occurrence of lateral acceleration and yaw rate”, according to the present disclosure, cornering stiffness may be estimated through a flow of “obtaining of lateral acceleration and yaw rate→vehicle lateral direction model→tire lateral force calculation→tire cornering stiffness estimation”.

In addition, the apparatus 100 according to the present disclosure may detect a road surface condition by using a cornering stiffness estimation value of a tire based on information obtainable from a vehicle. Accordingly, the present disclosure can detect the road surface condition without using a separate sensor for estimating the road surface condition.

That is, since the tire cornering stiffness varies depending on the road surface condition, the road surface condition may be determined based on the cornering stiffness when the cornering stiffness is given. The present disclosure proposes a method for determining a road surface condition based on a cornering stiffness estimation value obtained using lateral acceleration, yaw rate, and longitudinal speed, which are signals available in current mass-produced vehicles.

To this end, the apparatus 100 may include one or more processors 110, a computer readable storage medium 130, and a communication bus 150.

The processor 110 may control the apparatus 100 to operate. For example, the processor 110 may execute one or more programs 131 stored in the computer readable storage medium 130. The one or more programs 131 may include one or more computer-executable instructions. The computer-executable instructions may be configured to cause the apparatus 100 to estimate cornering stiffness of a tire and to perform an operation for detecting a road surface condition using the cornering stiffness estimation value of the tire when executed by the processor 110.

The computer readable storage medium 130 is configured to store computer-executable instructions or program codes, program data and/or other suitable form of information for estimating the cornering stiffness of a tire and detecting a road surface condition using the cornering stiffness estimation value of the tire. The program 131 stored in the computer readable storage medium 130 includes a set of instructions executable by the processor 110. In one embodiment, the computer readable storage medium 130 may include a memory (volatile memory such as random access memory, non-volatile memory, or a suitable combination thereof), one or more magnetic disk storage devices, optical disk storage devices, flash memory devices, other forms of storage media that can be accessed by the apparatus 100 and that can store desired information, or suitable combinations thereof.

The communication bus 150 interconnects the processor 110, the computer readable storage medium 130, and various other components of the apparatus 100.

The apparatus 100 may also include one or more input/output interfaces 170 that provide interfaces for one or more input/output devices, and one or more communication interfaces 190. The input/output interface 170 and the communication interface 190 are connected to the communication bus 150. The input/output devices (not shown) mounted in a vehicle may be connected to other components of the apparatus 100 through the input/output interface 170.

Meanwhile, the apparatus 100 according to the present disclosure is implemented as an independent and separate module, is mounted in a vehicle, and receives vehicle information from an ECU (electronic control unit) of the vehicle, and may perform the tire cornering stiffness estimation method and the road surface condition detection method using the tire cornering stiffness estimation value. As a matter of course, in the present disclosure, the tire cornering stiffness estimation method and the road surface condition detection method using the tire cornering stiffness estimation value may be implemented in a software form and installed in a vehicle, and the ECU of the vehicle may perform the tire cornering stiffness estimation method and the road surface condition detection method using the tire cornering stiffness estimation value. In this case, the ECU of the vehicle may serve as the processor 110 of the apparatus 100 according to the present disclosure.

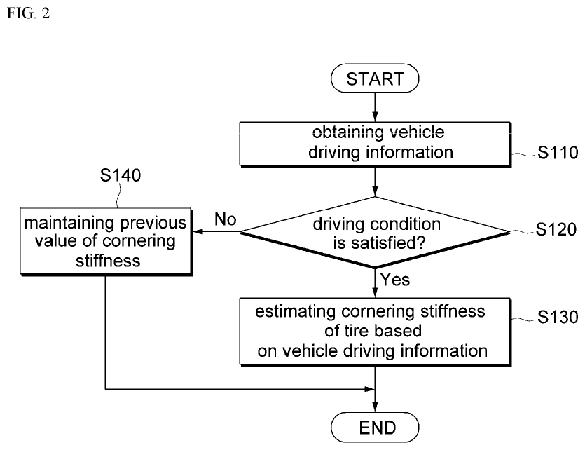

Next, the tire cornering stiffness estimation method according to an exemplary embodiment of the present disclosure will be described with reference to FIGS. 2 to 7.

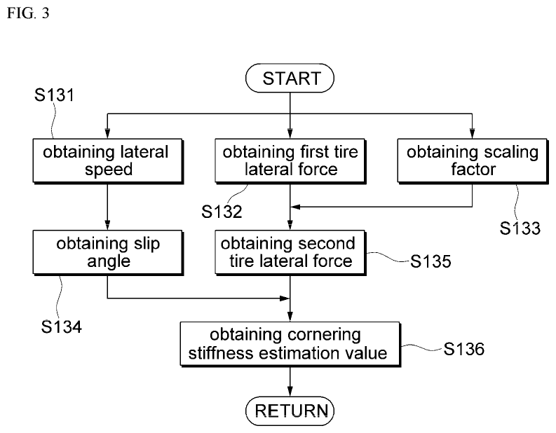

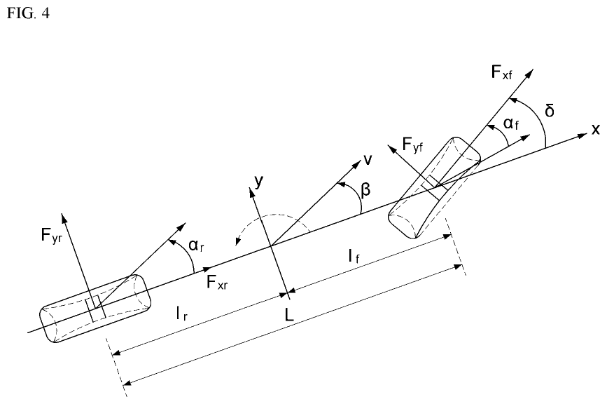

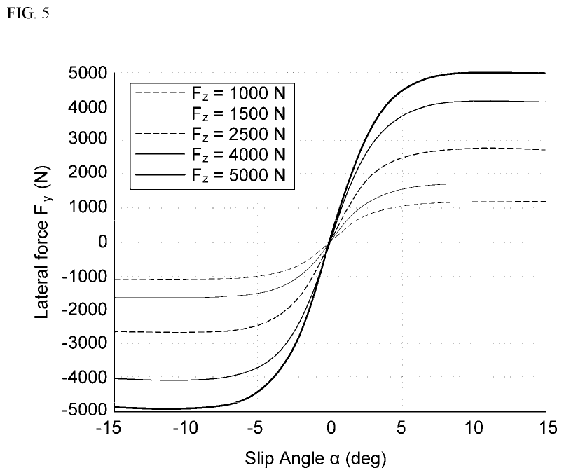

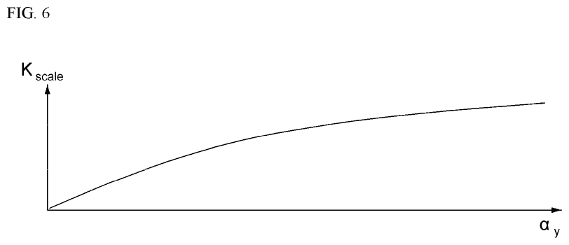

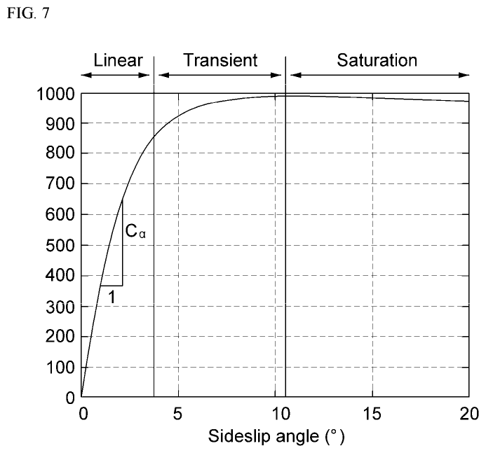

FIG. 2 is a flowchart illustrating the tire cornering stiffness estimation method according to an exemplary embodiment of the present disclosure, FIG. 3 is a flowchart for explaining a step of estimating cornering stiffness shown in FIG. 2, FIG. 4 is a diagram for explaining a bicycle model, which is a vehicle lateral dynamics model according to the exemplary embodiment of the present disclosure, FIG. 5 is a diagram for explaining influence of tire vertical force on tire lateral force according to the exemplary embodiment of the present disclosure, FIG. 6 is a diagram for explaining scaling factor information according to the exemplary embodiment of the present disclosure, and FIG. 7 is a diagram for explaining the relationship between a side slip angle and a tire lateral force according to the exemplary embodiment of the present disclosure.

Referring to FIG. 2, the processor 110 of the apparatus 100 may obtain vehicle driving information (S110).

In this case, the vehicle driving information may include a lateral acceleration a_{y} of a vehicle, a yaw rate r of the vehicle, and a longitudinal velocity vₓ of the vehicle.

For example, the lateral acceleration a_{y} and the yaw rate r may be obtained through a sensor that exists for an electronic stability control (ESC) function. The longitudinal speed vₓ may be obtained through a wheel speed (wheel rotational speed) sensor that exists for an anti-lock brake system (ABS) function.

Then, the processor 110 may check whether a preset driving condition is satisfied (S120).

In this case, the driving condition may include a case where an absolute value of variation of the longitudinal speed vₓ is less than a preset first reference value and an absolute value of variation of the lateral acceleration a_{y} is less than a preset second reference value.

That is, since the driving road environment of the vehicle does not continuously frequently change, cornering stiffness may be continuously estimated only in the general driving situation of the vehicle, and the previously estimated cornering stiffness may be maintained in cases other than the general driving situation. Considering this characteristic, the first reference value may be set to reflect the case where the longitudinal speed is constant, and the second reference value may be set to reflect the lateral motion in a linear region.

When the driving condition is satisfied (Yes in S120), the processor 110 may estimate cornering stiffness of the tire based on the vehicle driving information (S130).

That is, the processor 110 may estimate the cornering stiffness of the tire based on the vehicle driving information using the bicycle model and the linear tire model, which are vehicle lateral dynamics models, as shown in FIG. 4.

Specifically, referring to FIG. 3, the processor 110 may obtain a lateral speed based on the vehicle driving information (S131).

That is, the processor 110 may calculate the lateral speed v_{y} based on the lateral acceleration a_{y}, the yaw rate r, and the longitudinal speed vₓ.

For example, the processor 110 may calculate the lateral speed v_{y} using a lateral acceleration relational expression such as the following Equation 1.

$${a}_{y} = {v}_{{y}^{+}} {v}_{x} r \qquad ( Equation 1 )$$

where r represents the yaw rate, which is a change rate of a yaw angle ψ.

That is, the processor 110 may calculate the lateral speed v_{y} through the following Equation 2.

$${v}_{y} = \int {v}_{y} dt = \int {a}_{y} - {v}_{x} rdt \\ {v}_{y} ( k ) = {v}_{y} ( k - 1 ) + ( {a}_{y} - {v}_{x} r ) Δ T \qquad ( Equation 2 )$$

In addition, the processor 110 may obtain a lateral force of a first tire based on the vehicle driving information (S132).

For example, the processor 110 may obtain the first tire lateral force through the following Equations 3 and 4 representing the bicycle model that is the vehicle lateral dynamics model as shown in FIG. 4.

$${ma}_{y} = {F}_{yf} + {F}_{yr} \qquad ( Equation 3 )$$

where m represents a mass of the vehicle, F_{yf} represents a first front tire lateral force, and F_{yr} represents a first rear tire lateral force.

$${I}_{z} r = {l}_{f} {F}_{yf} - {l}_{r} {F}_{yr} \qquad ( Equation 4 )$$

where I_{z} represents a z-axis moment of inertia, l_{f} represents a front wheel length between the center of front and rear wheels and the front wheel, and lᵣ represents a rear wheel length between the center of the front and rear wheels and the rear wheel.

The lateral acceleration a_{y}, the yaw rate r, and the longitudinal speed vₓ are signals available in existing vehicles, and the mass m of the vehicle, the z-axis moment of inertia I_{z}, the front wheel length l_{f}, the rear wheel length lᵣ, and the total length between the front and rear wheels L (=l_{f}+lᵣ) are already known information, so based on Equations 3 and 4, the first front tire lateral force F_{yf} and the first rear tire lateral force F_{yr} can be calculated.

That is, the processor 110 may calculate the first front tire lateral force F_{yf} based on the lateral acceleration a_{y}, the yaw rate r, the total length between the front and rear wheels L, the z-axis moment of inertia I_{z}, the mass m of the vehicle, and the rear wheel length lᵣ between the center of the front and rear wheels and the rear wheel. For example, the processor 110 may calculate the first front tire lateral force F_{yf} through the following Equation 5.

$${F}_{yf} = \frac{{l}_{r} {ma}_{y} + {I}_{z} r}{L} \qquad ( Equation 5 )$$

In addition, the processor 110 may calculate the first rear tire lateral force F_{fr} based on the lateral acceleration a_{y}, the yaw rate r, the total length L, the z-axis moment of inertia I_{z}, the mass m, and the front wheel length l_{f} between the center of the front and rear wheels and the front wheel. For example, the processor 110 may calculate the first rear tire lateral force F_{yr} through the following Equation 6.

$${F}_{yr} = \frac{{l}_{f} {ma}_{y} - {I}_{z} r}{L} \qquad ( Equation 6 )$$

Further, the processor 110 may obtain a first tire lateral force including the first front tire lateral force F_{yf} and the first rear tire lateral force F_{yr}.

Furthermore, the processor 110 may obtain a scaling factor based on the vehicle driving information (S133).

In this case, the scaling factor k_{scale} refers to a factor for reflecting the influence of tire vertical force. The tire lateral force is influenced by tire vertical forces F_{zf} and F_{zr}. As shown in FIG. 5, the tire lateral force increases as the tire vertical force increases due to an increase in traction force. Depending on the lateral motion (roll motion) of the vehicle, the vertical load on the rotating inner and outer wheels is varied. Depending on the longitudinal motion (pitch motion) of the vehicle, the vertical load on the front and rear wheels is varied. The vertical force on the (left and right) front wheels can be expressed as in the following Equation 7, and the vertical force on the (left and right) rear wheels can be expressed as in the following Equation 8.

$${F}_{zfl} = {m}_{w} g + \frac{{Mgl}_{r}}{2 ( {l}_{r} + {l}_{f} )} - \frac{{Mh}_{CG} {a}_{x}}{2 ( {l}_{r} + {l}_{f} )} - \frac{{Mh}_{CG} {a}_{y}}{4 {l}_{s}} {F}_{zfr} = {m}_{w} g + \frac{{Mgl}_{r}}{2 ( {l}_{r} + {l}_{f} )} - \frac{{Mh}_{CG} {a}_{x}}{2 ( {l}_{r} + {l}_{f} )} + \frac{{Mh}_{CG} {a}_{y}}{4 {l}_{s}} \qquad ( Equation 7 )$$

where F_{zfl} represents the vertical force on the left front wheel, F_{zfr} represents the normal force on the right front wheel, m_{w} represents the mass of the wheel, g represents the gravitational acceleration, M represents the mass of the vehicle, and h_{CG} represents the height of the center of mass of the vehicle.

$${F}_{zrl} = {m}_{w} g + \frac{{Mgl}_{f} + {Mh}_{CG} {a}_{x}}{2 ( {l}_{r} + {l}_{f} )} - \frac{{Mh}_{CG} {a}_{y}}{4 {l}_{s}} {F}_{zrr} = {m}_{w} g + \frac{{Mgl}_{f} + {Mh}_{CG} {a}_{x}}{2 ( {l}_{r} + {l}_{f} )} + \frac{{Mh}_{CG} {a}_{y}}{4 {l}_{s}} \qquad ( Equation 8 )$$

where F_{zrl} represents the vertical force on the left rear wheel, and F_{zrr} represents the vertical force on the right rear wheel.

The vertical force depends on the longitudinal acceleration and lateral acceleration of the vehicle. When the longitudinal speed vₓ is constant (aₓ=0), only the lateral acceleration aₓ is affected. Accordingly, in Equation 7, the first and second terms are fixed values, the third term is zero since the longitudinal acceleration aₓ is 0, and only the fourth term is determined by the lateral acceleration a_{y}. In Equation 8, the first term is a fixed value, the second term is zero since the longitudinal acceleration aₓ is 0, and only the third term is determined by the lateral acceleration a_{y}.

That is, the processor 110 can obtain a scaling factor k_{scale} corresponding to the lateral acceleration a_{y} by using scaling factor information in which scaling factors are mapped for respective lateral accelerations.

For example, since the present disclosure uses the bicycle model having one front wheel and one rear wheel, which does not consider left and right wheels, in order to reflect the influence on the lateral acceleration, the scaling factor k_{scale} may be defined as a tuning parameter map based on the lateral acceleration a_{y}, that is, scaling factor information, as shown in FIG. 6. The corresponding scaling factor information (i.e., the tuning parameter map) may be used as a tuning parameter in vehicle control algorithm software to enable optimization in an actual application vehicle. The corresponding scaling factor information (i.e., the tuning parameter map) varies for each vehicle model according to design specifications of the vehicle, and optimization is performed through tuning only once initially for each vehicle model. In this case, the scaling factor information (i.e., the tuning parameter map) may be formed in the form of “k_{scale}=f(a_{y})” as shown in FIG. 6. As a matter of course, the tuning autonomy may be increased by making the scaling factor information (i.e., the tuning parameter map) have a plurality of break points according to the lateral acceleration a_{y}. For example, the scaling factor information (i.e., the tuning parameter map) may have N nodes as shown in the following Table 1.

TABLE 1

| a_{y} | b₁ | b₂ | b₃ | . . . | b_{N} |
|---|---|---|---|---|---|
| k_{scale} | xx | xx | xx | . . . | xx |

Then, the processor 110 may obtain a slip angle based on the vehicle driving information and the lateral speed (S134).

That is, the processor 110 may calculate a front wheel slip angle cu based on the yaw rate r, the longitudinal speed vₓ, the lateral speed f_{y}, and the front wheel length l_{f}.

For example, since a vehicle behaves in the linear region shown in FIG. 7 in a general driving situation, the processor 110 may calculate the front wheel slip angle cu through the following Equation 9 in consideration of the linear region.

$${α}_{f} = {tan}^{- 1} ( \frac{{v}_{y} + {l}_{f} r}{{v}_{x}} ) - {δ}_{f} ≅ \frac{{v}_{y} + {l}_{f} r}{{v}_{x}} - {δ}_{j} \qquad ( Equation 9 )$$

In addition, the processor 110 may calculate a rear wheel slip angle α_{f} based on the yaw rate r, the longitudinal velocity vₓ, the lateral velocity v_{y}, and the rear wheel length lᵣ.

For example, since a vehicle behaves in the linear region shown in FIG. 7 in a general driving situation, the processor 110 may calculate the rear wheel slip angle αᵣ through the following Equation 10 in consideration of the linear region.

$${α}_{r} = {tan}^{- 1} ( \frac{{v}_{y} - {l}_{r} r}{{v}_{x}} ) ≅ \frac{{v}_{y} - {l}_{r} r}{{v}_{x}} \qquad ( Equation 10 )$$

In addition, the processor 110 may obtain a slip angle including the front wheel slip angle α_{f} and the rear wheel slip angle αᵣ.

Moreover, the processor 110 may obtain a second tire lateral force based on the first tire lateral force and the scaling factor (S135).

That is, the processor 110 may calculate a second front tire lateral force F_{yfs} based on the first front tire lateral force F_{yf} and the scaling factor k_{scale}.

For example, the processor 110 may calculate the second front tire lateral force F_{yfs} through the following Equation 11.

$${F}_{yfs} = {k}_{scale} \times {F}_{yj} \qquad ( Equation 11 )$$

In addition, the processor 110 may calculate a second rear tire lateral force F_{yrs} based on the first rear tire lateral force F_{yr} and the scaling factor k_{scale}.

For example, the processor 110 may calculate the second rear tire lateral force F_{yrs} through the following Equation 12.

$${F}_{yrs} = {k}_{scale} \times {F}_{yr} \qquad ( Equation 12 )$$

In addition, the processor 110 may obtain a second tire lateral force including the second front tire lateral force F_{yfs} and the second rear tire lateral force F_{yrs}.

Then, the processor 110 may obtain a cornering stiffness estimation value based on the second tire lateral force and the slip angle (S136).

That is, the processor 110 may calculate the front wheel cornering stiffness estimation value C_{f,est} based on the second front tire lateral force F_{yfs} and the front wheel slip angle α_{f}.

For example, the processor 110 may calculate the front wheel cornering stiffness estimation value C_{f,est} through the following Equation 13.

$${C}_{f , est} = \frac{{F}_{yfs}}{{α}_{f}} \qquad ( Equation 13 )$$

In addition, the processor 110 may calculate a rear wheel cornering stiffness estimation value C_{f,est} based on the second rear wheel lateral force F_{yrs} and the rear wheel slip angle αᵣ.

For example, the processor 110 may calculate the rear wheel cornering stiffness estimation value C_{f,est} through the following Equation 14.

$${C}_{r , est} = \frac{{F}_{yrs}}{{α}_{r}} \qquad ( Equation 14 )$$

In addition, the processor 110 may obtain a cornering stiffness estimation value including the front wheel cornering stiffness estimation value C_{f,est} and the rear wheel cornering stiffness estimation value C_{r,est}.

Meanwhile, when the driving condition is not satisfied (No in S120), the processor 110 may maintain a previous cornering stiffness value (S140).

That is, the processor 110 may maintain the previously estimated cornering stiffness when the driving condition is not satisfied.

Unlike conventional methods that require a separate sensor or a complex vehicle state estimator such as a Kalman filter, the present disclosure can be easily applied to current mass-produced vehicles without the separate sensor or the complex vehicle state estimator, using only the signals (lateral acceleration, yaw rate, and longitudinal speed) available in the mass-produced vehicles.

In addition, the present disclosure proposes the scaling factor k_{scale} of a tuning map type based on the lateral acceleration ay to correct the tire lateral force depending on the tire vertical force, so that more accurate cornering stiffness estimation can be obtained and the present disclosure can be applied to various types of vehicles due to easy optimization by tuning.

Further, the present disclosure is easy to implement and apply to actual vehicles by using the simple models such as the bicycle model and the linear tire model, which are vehicle lateral dynamics models. Furthermore, even when the simple model is used, the reliability and accuracy of the cornering stiffness estimation value can be increased by determining a driving situation in which the corresponding model is valid as a precedent condition prior to the cornering stiffness estimation.

Moreover, the tire cornering stiffness estimated according to the present disclosure can be used in road surface determination or steering/braking/suspension control algorithms.

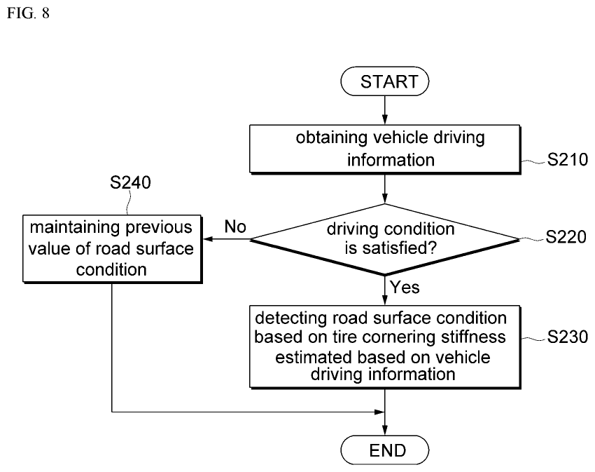

Next, a road surface condition detection method using a tire cornering stiffness estimation value according to an exemplary embodiment of the present disclosure will be described with reference to FIGS. 8 to 10.

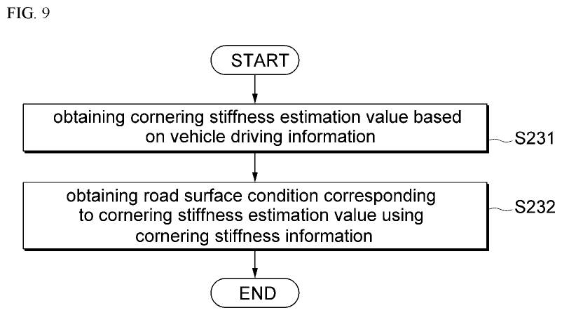

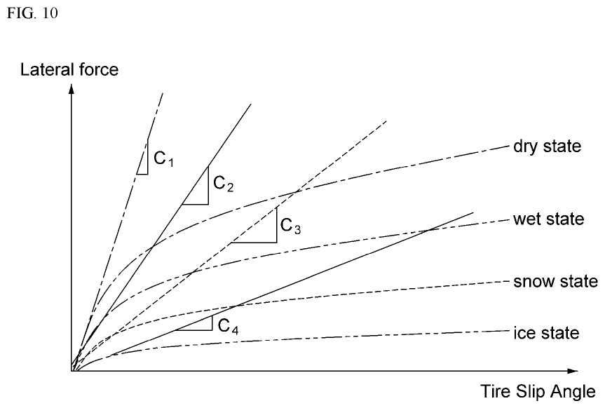

FIG. 8 is a flowchart illustrating the road surface condition detection method using a tire cornering stiffness estimation value according to an exemplary embodiment of the present disclosure, FIG. 9 is a flowchart for explaining a step of detecting a road surface condition shown in FIG. 8, and FIG. 10 is a diagram for explaining cornering stiffness information according to the exemplary embodiment of the present disclosure.

Referring to FIG. 8, the processor 110 of the apparatus 100 may obtain vehicle driving information (S210).

In this case, the vehicle driving information may include a lateral acceleration a_{y} of a vehicle, a yaw rate r of the vehicle, and a longitudinal velocity vₓ of the vehicle.

Then, the processor 110 may check whether a preset driving condition is satisfied (S220).

In this case, the driving condition may include a case where an absolute value of variation of the longitudinal speed vₓ is less than a preset first reference value and an absolute value of the lateral acceleration a_{y} is less than a preset second reference value.

That is, since the driving road environment of the vehicle does not continuously frequently change, the road surface condition may be continuously estimated only in the general driving situation of the vehicle, and the previously estimated road surface condition may be maintained in a case other than the general driving situation. Considering this characteristic, the first reference value may be set to reflect the case where the longitudinal speed is constant, and the second reference value may be set to reflect the lateral motion in a linear region.

When the driving condition is satisfied (Yes in S220), the processor 110 may detect a road surface condition based on the cornering stiffness of the tire estimated based on the vehicle driving information (S230).

In this case, the road surface condition may include a dry state, a wet state, a snow state, and an ice state.

Specifically, referring to FIG. 9, the processor 110 may obtain a cornering stiffness estimation value based on the vehicle driving information (S231).

That is, the processor 110 may obtain a cornering stiffness estimation value based on the vehicle driving information using the bicycle model and the linear tire model, which are vehicle lateral dynamics models. Since the obtaining of the cornering stiffness estimation value is the same as that described above, a detailed description thereof will be omitted.

Then, the processor 110 may obtain a road surface condition corresponding to the cornering stiffness estimation value by using the cornering stiffness estimation value (S232).

That is, the processor 110 may obtain a road surface condition corresponding to the cornering stiffness estimation value by using cornering stiffness information in which road surface conditions are mapped for respective cornering stiffness ranges.

In this case, when the cornering stiffness estimation value includes the front wheel cornering stiffness estimation value C_{f,est} and the rear wheel cornering stiffness estimation value C_{f,est}, the processor 110 may obtain a cornering stiffness estimation value C from the front wheel cornering stiffness estimation value C_{f,est} and the rear wheel cornering stiffness estimation value C_{f,est} using a method such as average or weighted sum. In this case, in the case of using the weighted sum, the processor 110 may obtain the cornering stiffness estimation value C by varying weights for the front wheels and the rear wheels according to the driving type (front-wheel-based driving, rear-wheel-based driving, etc.) of the vehicle.

In this case, in the cornering stiffness information, road surface conditions may be mapped for respective cornering stiffness ranges by using a boundary reference value set based on a physical phenomenon of the road surface and a boundary adjustment value that can be changed based on vehicle characteristics.

For example, in the cornering stiffness information, the road surface conditions may be mapped for respective cornering stiffness ranges as follows, using a relationship between the road surface conditions and the cornering stiffness as shown in FIG. 10.

First range (dry state): C₁+Δ_{th,1}<C

Second range (wet state): C₂+Δ_{th,2}<C≤C₁+Δ_{th,1}

Third range (snow state): C₃+Δ_{th,3}<C≤C₂+Δ_{th,2}

Fourth range (ice state): C≤C₃+Δ_{th,3}

In this case, C represents the cornering stiffness estimation value, C₁, C₂, and C₃ represent boundary reference values and are fixed values set based on physical phenomena of the road surface, Δ_{th,1}, Δ_{th,2}, and Δ_{th,3} indicate boundary adjustment values and are tuning parameters having+/−values. It is possible to optimize for each vehicle through the boundary adjustment values which are tuning parameters.

In other words, the processor 110 may obtain a cornering stiffness range corresponding to the cornering stiffness estimation value from the cornering stiffness information. In addition, the processor 110 may obtain the road surface condition corresponding to the obtained cornering stiffness range as the road surface condition corresponding to the cornering stiffness estimation value.

On the other hand, when the driving condition is not satisfied (No in S220), the processor 110 may maintain a previous value of the road surface condition (S240).

That is, the processor 110 may maintain the previously detected road surface condition when the driving condition is not satisfied.

As described above, the present disclosure can be easily applied to current mass-produced vehicles since the road surface condition is determined based on the cornering stiffness estimation value obtained using only the signals (lateral acceleration, yaw rate, and longitudinal speed) available in the mass-produced vehicles.

In addition, the road surface condition information detected according to the present disclosure is important information about the environment, and can be used for autonomous driving functions as well as control algorithms for chassis such as steering/braking/suspension, and thus can be utilized in many ways.

Further, the present disclosure proposes the boundary adjustment values, which are tunable parameters having+/−values, in boundary range classification for road surface estimation, so that optimization is easy and application to various types of vehicles is possible through this.

The operations according to the present embodiments may be implemented in the form of program instructions that can be executed through various computer units, and recorded in a computer readable storage medium. The computer readable storage medium refers to any medium that participates in providing instructions to a processor for execution. The computer readable storage medium may include program instructions, data files, data structures, or combinations thereof. For example, the computer readable storage medium may include a magnetic medium, an optical recording medium, a memory, and the like. The computer program may be distributed on computer systems connected through a network and may include computer readable codes stored and executed in the distributed manner. Functional programs, codes, and code segments for implementing the present embodiment may be easily inferred by programmers in the technical field to which the present embodiments pertain.

The present embodiments are for explaining the technical idea of the present disclosure, and the scope of the technical idea of the present disclosure is not limited by the present embodiments. The protection scope of the present disclosure should be interpreted by the following claims, and all technical ideas within the scope equivalent thereto should be construed as being included in the scope of the present disclosure.

What is claimed is:

1. A tire cornering stiffness estimation method comprising:
obtaining vehicle driving information; and
estimating cornering stiffness of a tire based on the vehicle driving information using a bicycle model and a linear tire model, which are vehicle lateral dynamics models.

2. The tire cornering stiffness estimation method of claim 1, wherein the vehicle driving information includes a lateral acceleration of a vehicle, a yaw rate of the vehicle, and a longitudinal speed of the vehicle.

3. The tire cornering stiffness estimation method of claim 2, wherein the estimating cornering stiffness includes:
obtaining a lateral speed based on the vehicle driving information;
obtaining a first tire lateral force based on the vehicle driving information;
obtaining a scaling factor for reflecting influence of tire vertical force based on the vehicle driving information;
obtaining a slip angle based on the vehicle driving information and the lateral speed;
obtaining a second tire lateral force based on the first tire lateral force and the scaling factor; and
obtaining a cornering stiffness estimation value based on the second tire lateral force and the slip angle.

4. The tire cornering stiffness estimation method of claim 3, wherein the obtaining a lateral speed includes calculating the lateral speed v_{y} based on the lateral acceleration a_{y}, the yaw rate r, and the longitudinal speed vₓ.

5. The tire cornering stiffness estimation method of claim 4, wherein the obtaining a first tire lateral force includes:
calculating a first front wheel tire lateral force F_{yf} based on the lateral acceleration a_{y}, the yaw rate r, a total length L between front and rear wheels of the vehicle, a z-axis moment of inertia I_{z}, a mass m of the vehicle, and a rear wheel length lᵣ between a center of the front and rear wheels and the rear wheel;
calculating a first rear tire lateral force F_{yr} based on the lateral acceleration a_{y}, the yaw rate r, the total length L, the z-axis moment of inertia I_{z}, the mass m, and a front wheel length l_{f} between the center of the front and rear wheels and the front wheel; and
obtaining the first tire lateral force including the first front tire lateral force F_{yf} and the first rear wheel tire lateral force F_{yr}.

6. The tire cornering stiffness estimation method of claim 5, wherein the obtaining a scaling factor includes obtaining the scaling factor k_{scale} corresponding to the lateral acceleration a_{y} using scaling factor information in which scaling factors are mapped for respective lateral accelerations.

7. The tire cornering stiffness estimation method of claim 6, wherein the obtaining a slip angle includes:
calculating a front wheel slip angle α_{f} based on the yaw rate r, the longitudinal speed vₓ, the lateral speed v_{y}, and the front wheel length l_{f};
calculating a rear wheel slip angle αᵣ based on the yaw rate r, the longitudinal speed vₓ, the lateral speed v_{y}, and the rear wheel length lᵣ; and
obtaining the slip angle including the front wheel slip angle α_{f} and the rear wheel slip angle αᵣ.

8. The tire cornering stiffness estimation method of claim 7, wherein the obtaining a second tire lateral force includes:
calculating a second front tire lateral force F_{yfs} based on the first front tire lateral force F_{yf} and the scaling factor k_{scale};
calculating a second rear tire lateral force F_{yrs} based on the first rear tire lateral force F_{yr} and the scaling factor k_{scale}; and
obtaining the second tire lateral force including the second front tire lateral force F_{yfs} and the second rear tire lateral force F_{yrs}.

9. The tire cornering stiffness estimation method of claim 8, wherein the obtaining a cornering stiffness estimation value includes:
calculating a front wheel cornering stiffness estimation value C_{f,est} based on the second front tire lateral force F_{yfs} and the front wheel slip angle α_{f};
calculating a rear wheel cornering stiffness estimation value C_{r,est} based on the second rear tire lateral force F_{yrs} and the rear wheel slip angle αᵣ; and
obtaining the cornering stiffness estimation value including the front wheel cornering stiffness estimation value C_{f,est} and the rear wheel cornering stiffness estimation value C_{r,est}.

10. The tire cornering stiffness estimation method of claim 2, wherein the estimating cornering stiffness of a tire includes:
estimating the cornering stiffness when a preset driving condition is satisfied; and
maintaining a previously estimated cornering stiffness when the driving condition is not satisfied.

11. The tire cornering stiffness estimation method of claim 10, wherein the driving condition includes a case where an absolute value of variation of the longitudinal speed vₓ is less than a preset first reference value and an absolute value of the lateral acceleration a_{y} is less than a preset second reference value.

12. A tire cornering stiffness estimation apparatus comprising:
a memory storing one or more programs for estimating tire cornering stiffness; and
one or more processors that perform an operation for estimating tire cornering stiffness according to the one or more programs stored in the memory,
wherein the one or more processors are configured to perform:
obtaining vehicle driving information of a vehicle; and
estimating cornering stiffness of a tire based on the vehicle driving information using a bicycle model and a linear tire model, which are vehicle lateral dynamics models.

13. The tire cornering stiffness estimation apparatus of claim 12, wherein the one or more processors are further configured to perform controlling at least one of a steering system, a braking system, or a suspension system of the vehicle by using the estimated cornering stiffness of the tire.

14. The tire cornering stiffness estimation apparatus of claim 12, wherein the vehicle driving information includes a lateral acceleration of the vehicle, a yaw rate of the vehicle, and a longitudinal speed of the vehicle.

15. The tire cornering stiffness estimation apparatus of claim 14, wherein the one or more processors perform:
obtaining a lateral speed based on the vehicle driving information;
obtaining a first tire lateral force based on the vehicle driving information;
obtaining a scaling factor for reflecting influence of tire vertical force based on the vehicle driving information;
obtaining a slip angle based on the vehicle driving information and the lateral speed;
obtaining a second tire lateral force based on the first tire lateral force and the scaling factor; and
obtaining a cornering stiffness estimation value based on the second tire lateral force and the slip angle.

16. A road surface condition detection method using a tire cornering stiffness estimation value, the method comprising:
obtaining vehicle driving information; and
detecting a road surface condition based on cornering stiffness of a tire estimated based on the vehicle driving information.

17. The road surface condition detection method of claim 16, wherein the detecting a road surface condition includes:
obtaining a cornering stiffness estimation value based on the vehicle driving information using a bicycle model and a linear tire model, which are vehicle lateral dynamics models; and
obtaining the road surface condition corresponding to the cornering stiffness estimation value by using cornering stiffness information in which road surface conditions are mapped for respective cornering stiffness ranges.

18. The road surface condition detection method of claim 17, wherein the obtaining a road surface condition includes:
obtaining a cornering stiffness range corresponding to the cornering stiffness estimation value from the cornering stiffness information; and
obtaining a road surface condition corresponding to the obtained cornering stiffness range as the road surface condition corresponding to the cornering stiffness estimation value.

19. The road surface condition detection method of claim 17, wherein in the cornering stiffness information, the road surface conditions are mapped for the respective cornering stiffness ranges using a boundary reference value set based on a physical phenomenon of a road surface and a boundary adjustment value changeable based on vehicle characteristics.

20. The road surface condition detection method of claim 16, wherein the detecting a road surface condition includes:
detecting the road surface condition when a preset driving condition is satisfied; and
maintaining a previously detected road surface condition when the driving condition is not satisfied.
